(19) United States
(12) Patent Application Publication
(10) Pub. No.: US 2026/0038297 A1
(43) Pub. Date: Feb. 5, 2026

(54) FINGERPRINT MODULE AND ELECTRONIC DEVICE

(71) Applicant: SHENZHEN GOODIX TECHNOLOGY CO., LTD., Shenzhen (CN)

(72) Inventors: Wenzheng LIU, Shenzhen (CN); Kai LIU, Shenzhen (CN)

(73) Assignee: SHENZHEN GOODIX TECHNOLOGY CO., LTD., Shenzhen (CN)

(21) Appl. No.: 19/358,121

(22) Filed: Oct. 14, 2025

Related U.S. Application Data
(63) Continuation of application No. PCT/CN2024/094055, filed on May 17, 2024.

(30) Foreign Application Priority Data
Sep. 12, 2023 (CN) 202322483086.5
Sep. 12, 2023 (CN) 202322483116.2
Sep. 12, 2023 (CN) 202322492295.6

(51) Int. Cl. G06V 40/13

(52) U.S. Cl. CPC G06V 40/1306; G06V 40/1329

(57) ABSTRACT

A fingerprint module and an electronic device are provided. The fingerprint module includes: a substrate, an acoustic layer, a first electrode layer, and a protective layer, the substrate being provided with a second electrode layer, one side of the acoustic layer being electrically connected to the second electrode layer, the other side of the acoustic layer being electrically connected to one side of the first electrode layer, and the protective layer being covered on the other side of the first electrode layer; the substrate being provided with a first electrical connection region, the first electrode layer and the second electrode layer being electrically connected to the first electrical connection region. The circuit board has a second electrical connection region being electrically connected with the first electrical connection region via a conductive adhesive layer. The circuit board being electrically connected to a processing unit external to the fingerprint module.

### CROSS-REFERENCE TO RELATED APPLICATIONS AND INCORPORATION BY REFERENCE

The present application is a continuation of PCT/CN2024/094055 filed on May 17, 2024 and titled “FINGERPRINT MODULE AND ELECTRONIC DEVICE” which claims the priority of the utility model application No. 202322483086.5 filed on Sep. 12, 2023 and entitled “FINGERPRINT MODULE AND ELECTRONIC DEVICE”, claims the priority of the utility model application No. 202322483116.2 filed on Sep. 12, 2023 and entitled “FINGERPRINT MODULE AND ELECTRONIC DEVICE”, and claims the priority of the utility model application No. 202322492295.6 filed on Sep. 12, 2023 and entitled “FINGERPRINT MODULE AND ELECTRONIC DEVICE”, the entire contents of which are hereby incorporated by reference.

### TECHNICAL FIELD

Embodiments of the present disclosure relate to the technical field of fingerprint modules, in particular to a fingerprint module and an electronic device.

### BACKGROUND

With the development of the consumer electronics industry, including but not limited to the evolving of display screens of mobile communication devices towards full-screen, consumers' demand for under-screen fingerprint recognition technology continues to grow. There are mainly two types of publicly available under-screen fingerprint recognition solutions: the first is an optical solution, and the second is an ultrasonic solution. Here, the performance of optical fingerprint modules is significantly affected by the optical transmittance of screens. With the increasing complexity of internal writing in display screens and the development of flexible screen solutions, the optical transmittance of screens has decreased, which makes the optical fingerprint solution unable to meet application requirements. On the other hand, ultrasonic fingerprint modules do not depend on the optical transmittance of screens, which makes the ultrasonic solution a good alternative.

Pixel circuits of ultrasonic sensors in the existing ultrasonic fingerprint solution are formed on a glass substrate using a thin-film transistor process.

However, due to the low pixel integration, poor stability, and inferior driving performance of the ultrasonic sensors manufactured using the thin-film transistor process, the size of the ultrasonic sensors is large, resulting in excessive space occupation by the ultrasonic fingerprint modules, which is unable to meet the space utilization requirements of mobile terminals. Therefore, a new technical solution for ultrasonic fingerprint modules is needed to meet the application requirements of current under-screen fingerprint recognition.

### SUMMARY

In view of this, embodiments of the present disclosure provide a fingerprint module and an electronic device to at least partially solve the above problems.

According to a first aspect of embodiments of the present disclosure, a fingerprint module is provided, including: an ultrasonic sensor and a circuit board; the ultrasonic sensor including a substrate, an acoustic layer, a first electrode layer, and a protective layer, the substrate being provided with a second electrode layer, one side of the acoustic layer being electrically connected to the second electrode layer, the other side of the acoustic layer being electrically connected to one side of the first electrode layer, and the protective layer being covered on the other side of the first electrode layer, where a sum of thicknesses of the acoustic layer, the first electrode layer, and the protective layer ranges from 37 μm to 43 μm, and a thickness of the substrate ranges from 85 μm to 115 μm; the substrate being provided with a first electrical connection region, the first electrode layer and the second electrode layer being electrically connected to the first electrical connection region, respectively, the circuit board being provided with a second electrical connection region, and the first electrical connection region and the second electrical connection region being electrically connected via a conductive adhesive layer; and the circuit board being electrically connected to a processing unit external to the fingerprint module, the acoustic layer being configured to emit an ultrasonic signal and receive an ultrasonic signal reflected by an external structure, the ultrasonic sensor being configured to convert the ultrasonic signal received by the acoustic layer into an electrical signal and send the electrical signal to the processing unit via the circuit board to enable the processing unit to perform fingerprint recognition based on the electrical signal, where a frequency of the ultrasonic signal emitted by the acoustic layer ranges from 11 MHz to 13 MHz.

According to a second aspect of embodiments of the present disclosure, a fingerprint module is provided, including: an ultrasonic sensor and a circuit board; the ultrasonic sensor including a substrate, an acoustic layer, a first electrode layer, and a protective layer, the substrate being provided with a second electrode layer, one side of the acoustic layer being electrically connected to the second electrode layer, the other side of the acoustic layer being electrically connected to one side of the first electrode layer, and the protective layer being covered on the other side of the first electrode layer, where a sum of thicknesses of the acoustic layer, the first electrode layer, and the protective layer ranges from 48 μm to 60 μm, and a thickness of the substrate ranges from 125 μm to 155 μm; the substrate being provided with a first electrical connection region, the first electrode layer and the second electrode layer being electrically connected to the first electrical connection region, respectively, the circuit board being provided with a second electrical connection region, and the first electrical connection region and the second electrical connection region being electrically connected via a conductive adhesive layer; and the circuit board being electrically connected to a processing unit external to the fingerprint module, the acoustic layer being configured to emit an ultrasonic signal and receive an ultrasonic signal reflected by an external structure, the ultrasonic sensor being configured to convert the ultrasonic signal received by the acoustic layer into an electrical signal and send the electrical signal to the processing unit via the circuit board to enable the processing unit to perform fingerprint recognition based on the electrical signal, where a frequency of the ultrasonic signal emitted by the acoustic layer ranges from 7 MHz to 9 MHz.

According to a third aspect of embodiments of the present disclosure, a fingerprint module is provided, including: an ultrasonic sensor and a circuit board; the ultrasonic sensor including a substrate, an acoustic layer, a first electrode layer, and a protective layer, the substrate being provided with a second electrode layer, one side of the acoustic layer being electrically connected to the second electrode layer, the other side of the acoustic layer being electrically connected to one side of the first electrode layer, and the protective layer being covered on the other side of the first electrode layer, where a sum of thicknesses of the acoustic layer, the first electrode layer, and the protective layer ranges from 44 μm to 50 μm, and a thickness of the substrate ranges from 85 μm to 115 μm; the substrate being provided with a first electrical connection region, the first electrode layer and the second electrode layer being electrically connected to the first electrical connection region, respectively, the circuit board being provided with a second electrical connection region, and the first electrical connection region and the second electrical connection region being electrically connected via a conductive adhesive layer; and the circuit board being electrically connected to a processing unit external to the fingerprint module, the acoustic layer being configured to emit an ultrasonic signal and receive an ultrasonic signal reflected by an external structure, the ultrasonic sensor being configured to convert the ultrasonic signal received by the acoustic layer into an electrical signal and send the electrical signal to the processing unit via the circuit board to enable the processing unit to perform fingerprint recognition based on the electrical signal, where a frequency of the ultrasonic signal emitted by the acoustic layer ranges from 9 MHz to 11 MHz.

According to a fourth aspect of embodiments of the present disclosure, an electronic device is provided, including: a processing unit, a screen, and the fingerprint module as described in the first aspect, the second aspect, or the third aspect of embodiments of the present disclosure, the fingerprint module is provided at a back side of the screen, and the processing unit is electrically connected to a circuit board in the fingerprint module.

The fingerprint module provided according to embodiments of the present disclosure includes the ultrasonic sensor and the circuit board, the ultrasonic sensor includes the acoustic layer, the substrate, the first electrode layer, and the protective layer. The acoustic layer may emit and receive the reflected ultrasonic signal, and the ultrasonic sensor may convert the ultrasonic signal received by the acoustic layer into an electrical signal, which is then transmitted by the circuit board to the processing unit external to the fingerprint module, thereby accomplishing ultrasonic fingerprint recognition. Since the present disclosure uses ultrasonic waves for fingerprint recognition in real time, it may be applied to electronic devices with low optical transmittance, compared to optical fingerprint recognition, and since the sum of thicknesses of the acoustic layer, the first electrode layer, and the protective layer ranges from 37 μm to 43 μm, and the thickness of the substrate ranges from 85 μm to 115 μm, the thickness of the entire ultrasonic sensor may be kept below 0.16 mm. Compared to conventional ultrasonic sensors manufactured using the thin-film transistor process, the ultrasonic sensor in the present disclosure may be applied to electronic devices having high space utilization requirements and thin thicknesses (e.g., ultra-thin mobile phones). Therefore, the fingerprint module is highly applicable and can meet the application requirements of the electronic device.

### BRIEF DESCRIPTION OF DRAWINGS

In order to more clearly illustrate the technical solution in embodiments of the present disclosure or the prior art, the accompanying drawings to be used in the description of the embodiments or the prior art will be briefly introduced below. Obviously, the accompanying drawings in the following description are only some of the embodiments recorded in the embodiments of the present disclosure, and those of ordinary skill in the art may also obtain other accompanying drawings based on these accompanying drawings.

FIG. 1 is a schematic diagram of a fingerprint module provided in an embodiment of the present disclosure;

FIG. 2 is a schematic diagram of a substrate of an ultrasonic sensor provided in an embodiment of the present disclosure;

FIG. 3 is a schematic diagram of a first electrical connection region provided in an embodiment of the present disclosure;

FIG. 4 is a schematic diagram of an adhesive layer provided in an embodiment of the present disclosure;

FIG. 5 is a schematic diagram of a circuit board provided in an embodiment of the present disclosure;

FIG. 6 is a schematic diagram of an electronic device provided in an embodiment of the present disclosure;

FIG. 7 is a schematic diagram of a specific application scenario of a fingerprint module provided in an embodiment of the present disclosure;

FIG. 8 is a front view of a connection relationship between a fingerprint module and a non-foldable screen provided in an embodiment of the present disclosure;

FIG. 9 is a cross-sectional view the connection relationship between a fingerprint module and a non-foldable screen provided in an embodiment of the present disclosure;

FIG. 10 is a front view of a connection relationship between another fingerprint module and a non-foldable screen provided in an embodiment of the present disclosure;

FIG. 11 is a cross-sectional view of the connection relationship between another fingerprint module and a non-foldable screen provided in an embodiment of the present disclosure;

FIG. 12 is a front view of a connection relationship between a fingerprint module and a foldable screen provided in an embodiment of the present disclosure;

FIG. 13 is a cross-sectional view of the connection relationship between a fingerprint module and a foldable screen provided in an embodiment of the present disclosure;

FIG. 14 is a front view of a connection relationship between another fingerprint module and a foldable screen provided in an embodiment of the present disclosure; and

FIG. 15 is a cross-sectional view of the connection relationship between another fingerprint module and a foldable screen provided in an embodiment of the present disclosure.

### DETAILED DESCRIPTION

In order to enable those in the art to better understand the technical solution in embodiments of the present disclosure, the technical solution in the embodiments of the present disclosure will be described clearly and completely in the following in conjunction with the accompanying drawings in the embodiments of the present disclosure. It is obvious that the described embodiments are only some of the embodiments in the embodiments of the present disclosure, but not all of the embodiments. Based on the embodiments of the present disclosure, all other embodiments obtained by those of ordinary skill in the art shall fall within the scope of protection of the embodiments of the present disclosure.

The terminology used in the present disclosure is used only for the purpose of describing particular embodiments and is not intended to limit the present disclosure. The singular forms of “a,” “the,” and “this” used in the present disclosure and the appended claims are also intended to include plural forms, unless the context clearly indicates otherwise. It should also be understood that the term “and/or” as used herein refers to and contains any or all possible combinations of one or more of the associated listed items.

It should be understood that while the terms “first”, “second”, “third”, etc. may be used in the present disclosure to describe various types of information, such information should not be limited to these terms. These terms are only used to distinguish the same type of information from one another. For example, without departing from the scope of the present disclosure, first information may also be referred to as second information, and similarly, second information may be referred to as first information. Depending on the context, as used herein, the word “if” may be interpreted as “when . . . ”, “upon . . . ” or “in response to determining”.

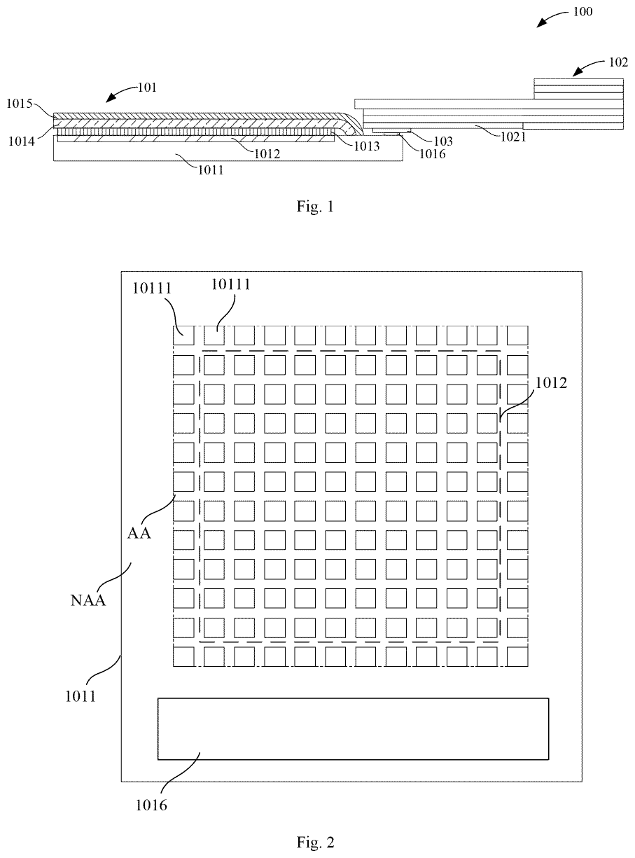

FIG. 1 is a schematic diagram of a fingerprint module provided in an embodiment of the present disclosure. As shown in FIG. 1, a fingerprint module 100 includes: an ultrasonic sensor 101 and a circuit board 102.

The ultrasonic sensor 101 including a substrate 1011, an acoustic layer 1013, a first electrode layer 1014, and a protective layer 1015, the substrate 1011 is provided with a second electrode layer 1012, one side of the acoustic layer 1013 is electrically connected to the second electrode layer 1012, the other side of the acoustic layer 1013 is electrically connected to one side of the first electrode layer 1014, and the protective layer 1015 is covered on the other side of the first electrode layer 1014, where a sum of thicknesses of the acoustic layer 1013, the first electrode layer 1014, and the protective layer 1015 ranges from 37 μm to 43 μm, and a thickness of the substrate 1011 ranges from 85 μm to 115 μm. The substrate 1011 is provided with a first electrical connection region 1016, the first electrode layer 1014 and the second electrode layer 1012 are electrically connected to the first electrical connection region 1016, respectively, the circuit board 102 is provided with a second electrical connection region 1021, and the first electrical connection region 1016 and the second electrical connection region 1021 are electrically connected via a conductive adhesive layer 103.

The circuit board 102 is electrically connected to a processing unit external to the fingerprint module 100, the acoustic layer 1013 is configured to emit an ultrasonic signal and receive an ultrasonic signal reflected by an external structure, the ultrasonic sensor 101 is configured to convert the ultrasonic signal received by the acoustic layer 1013 into an electrical signal and send the electrical signal to the processing unit via the circuit board 102 to enable the processing unit to perform fingerprint recognition based on the electrical signal, where a frequency of the ultrasonic signal emitted by the acoustic layer 1013 ranges from 11 MHz to 13 MHz.

The substrate 1011 of the ultrasonic sensor 101 is a silicon substrate, the substrate 1011 is provided with the second electrode layer 1012, and the second electrode layer 1012 and the substrate 1011 may be integrally molded, e.g., the second electrode layer 1012 may be a transistor formed on the silicon substrate, and the second electrode layer 1012 may also be a metal plate provided on the substrate 1011. One side of the acoustic layer 1013 is electrically connected to the second electrode layer 1012, the other side of the acoustic layer 1013 is electrically connected to the first electrode layer 1014, and the first electrode layer 1014 may be a conductive metal layer, e.g., a conductive metal layer such as a silver layer or a copper layer. Alternatively, in the case where the first electrode layer 1014 is a silver layer, for example, one or more layers of silver paste may be coated on the other side of the acoustic layer 1013 to form the first electrode layer 1014.

The ultrasonic sensor 101 further includes the protective layer 1015 that is covered on the other side of the first electrode layer 1014. The protective layer 1015 may prevent oxidation of the first electrode layer 1014 (e.g., a silver layer formed by the silver paste) or prevent degradation of the performance of the acoustic layer 1013, and the protective layer 1015 may also serve as an insulating layer to prevent short circuits between the first electrode layer 1014 and other structures.

The acoustic layer 1013 may emit an ultrasonic signal and receive an ultrasonic signal reflected by the external structure. In an example application scenario, the external structure may be a user's finger (referring to the example shown in FIG. 7, the finger is represented by a symbol 300), and the fingerprint module 100 may be used for under-screen fingerprint recognition. After the user touches a specific area on the screen with the finger, the acoustic layer 1013 of the ultrasonic sensor 101 in the fingerprint module 100 emits an ultrasonic signal, and the user's finger reflects at least part of the ultrasonic signal, and the acoustic layer 1013 receives the ultrasonic signal reflected back by the user's finger.

The ultrasonic sensor 101 may process the ultrasonic signal received by the acoustic layer 1013 into an electrical signal. Alternatively, an ultrasonic signal processing circuit may be formed on the substrate 1011 in the ultrasonic sensor 101, and the ultrasonic signal processing circuit may process the received ultrasonic signal into an electrical signal. After the ultrasonic sensor 101 processes the received ultrasonic signal into the electrical signal, the electrical signal may be sent to the processing unit external to the fingerprint module 100 via the circuit board 102 to enable the processing unit to perform fingerprint recognition based on the electrical signal.

The conductive adhesive layer 103 may be any conductive adhesive layer 103 structure, e.g., may be a conductive adhesive. In some alternative embodiments, the conductive adhesive layer 103 may be an Anisotropic Conductive Film (ACF). The anisotropic conductive film has the property of being perpendicularly conductive and parallelly non-conductive. Via the anisotropic conductive film (i.e., the conductive adhesive layer 103), the first electrical connection region 1016 of the ultrasonic sensor 101 may be reliably electrically connected to the second electrical connection region 1021 on the circuit board 102, and the first electrical connection region 1016 and the second electrical connection region 1021 may be electrically connected by means of lamination, which simplifies the complexity of manufacturing of the fingerprint module 100, and can more conveniently meet application requirements. Alternatively, the anisotropic conductive film has a thickness of 1-5 μm after being laminated by the first electrical connection region 1016 and the second electrical connection region 1021.

Alternatively, as shown in FIG. 1, after the first electrical connection region 1016 and the second electrical connection region 1021 are electrically connected via the conductive adhesive layer 103 (e.g., the anisotropic conductive film), a protective adhesive (e.g., the protective adhesive 105 as shown in FIG. 9, FIG. 11, FIG. 13 and FIG. 15) may be covered on a side of the conductive adhesive layer 103 that extends beyond the substrate, and the protective adhesive is in contact with at least the substrate 1011, the conductive adhesive layer 103, and the circuit board 102.

Since the protective adhesive is provided, the portion of the conductive adhesive layer 103 extending beyond the substrate 1011 may be protected, preventing damage to the portion of the conductive adhesive layer 103 extending beyond the substrate 1011, and also preventing the same portion of the conductive adhesive layer 103 from being exposed to the outside and resulting in short-circuits. In addition, since the protective adhesive is in contact with the substrate 1011 and the circuit board 102 (e.g., as shown in FIG. 9, FIG. 11, FIG. 13, and FIG. 15), the circuit board 102 may be prevented from detaching from the ultrasonic sensor 101, thus enhancing stability.

The fingerprint module 100 may be mounted on an electronic device during use. In the embodiments of the present disclosure, the type of the electronic device is not limited, and the electronic device may include but is not limited to mobile phones, tablet computers, or other electronic devices requiring a fingerprint recognition function. The processing unit may be any processing unit external to the fingerprint module 100. Alternatively, the processing unit may be a processing unit in the electronic device. The electronic device in the present disclosure will be described in detail below, detailed description thereof will be omitted herein.

In an embodiment of the present disclosure, the fingerprint module 100 includes the ultrasonic sensor 101 and the circuit board 102. The ultrasonic sensor 101 includes the acoustic layer 1013, the substrate 1011, the first electrode layer 1014, and the protective layer 1015. The acoustic layer 1013 may emit and receive the reflected ultrasonic signal, and the ultrasonic sensor 101 may convert the ultrasonic signal received by the acoustic layer 1013 into an electrical signal, which is then transmitted by the circuit board 102 to the processing unit external to the fingerprint module 100, thereby accomplishing ultrasonic fingerprint recognition. Since the present disclosure uses ultrasonic waves for fingerprint recognition in real time, it may be applied to electronic devices with low optical transmittance, compared to optical fingerprint recognition, and since the sum of thicknesses of the acoustic layer 1013, the first electrode layer 1014, and the protective layer 1015 ranges from 37 μm to 43 μm, and the thickness of the substrate 1011 ranges from 85 μm to 115 μm, the thickness of the entire ultrasonic sensor 101 may be kept below 0.16 mm. Compared to conventional ultrasonic sensors 101 manufactured using the thin-film transistor process, the ultrasonic sensor 101 in the present disclosure may be applied to electronic devices having high space utilization requirements and thin thicknesses (e.g., ultra-thin mobile phones). Therefore, the fingerprint module 100 is highly applicable and can meet the application requirements of the electronic device.

In a possible implementation, the sum of thicknesses of the acoustic layer 1013, the first electrode layer 1014, and the protective layer 1015 is 40 μm, the thickness of the substrate 1011 is 90 μm, and the frequency of the ultrasonic signal emitted by the acoustic layer 1013 is 12 MHz.

In an embodiment of the present disclosure, the sum of thicknesses of the acoustic layer 1013, the first electrode layer 1014, and the protective layer 1015 is 40 μm, and the thickness of the substrate 1011 is 90 μm, thereby achieving a balance between the performance and thickness of the ultrasonic sensor 101, and maintaining the minimum thickness with low performance degradation. In addition, the frequency of the ultrasonic signal emitted by the acoustic layer 1013 is 12 MHz, which may be matched with the thickness to enable ultrasonic waves to penetrate the ultrasonic sensor 101 of that thickness and the electronic device, may be applied to electronic devices having high space utilization requirements and thin thicknesses (e.g., ultra-thin mobile phones). Therefore, the fingerprint module 100 is highly applicable and can meet the application requirements of the electronic device.

In a possible implementation, as shown in FIG. 1, a fingerprint module 100 includes: an ultrasonic sensor 101 and a circuit board 102.

The ultrasonic sensor 101 includes a substrate 1011, an acoustic layer 1013, a first electrode layer 1014, and a protective layer 1015, the substrate 1011 is provided with a second electrode layer 1012, one side of the acoustic layer 1013 is electrically connected to the second electrode layer 1012, the other side of the acoustic layer 1013 is electrically connected to one side of the first electrode layer 1014, and the protective layer 1015 is covered on the other side of the first electrode layer 1014, where a sum of thicknesses of the acoustic layer 1013, the first electrode layer 1014, and the protective layer 1015 ranges from 48 μm to 60 μm, and a thickness of the substrate 1011 ranges from 125 μm to 155 μm. The substrate 1011 is provided with a first electrical connection region 1016, the first electrode layer 1014 and the second electrode layer 1012 are electrically connected to the first electrical connection region 1016, respectively, the circuit board 102 is provided with a second electrical connection region 1021, and the first electrical connection region 1016 and the second electrical connection region 1021 are electrically connected via a conductive adhesive layer 103.

The circuit board 102 is electrically connected to a processing unit external to the fingerprint module 100, the acoustic layer 1013 is configured to emit an ultrasonic signal and receive an ultrasonic signal reflected by an external structure, the ultrasonic sensor 101 is configured to convert the ultrasonic signal received by the acoustic layer 1013 into an electrical signal and send the electrical signal to the processing unit via the circuit board 102 to enable the processing unit to perform fingerprint recognition based on the electrical signal, where a frequency of the ultrasonic signal emitted by the acoustic layer 1013 ranges from 7 MHz to 9 MHz.

The substrate 1011 of the ultrasonic sensor 101 is a silicon substrate, the substrate 1011 is provided with the second electrode layer 1012, and the second electrode layer 1012 and the substrate 1011 may be integrally molded, e.g., the second electrode layer 1012 may be a transistor formed on the silicon substrate, and the second electrode layer 1012 may also be a metal plate provided on the substrate 1011. One side of the acoustic layer 1013 is electrically connected to the second electrode layer 1012, the other side of the acoustic layer 1013 is electrically connected to the first electrode layer 1014, and the first electrode layer 1014 may be a conductive metal layer, e.g., a conductive metal layer such as a silver layer or a copper layer. Alternatively, in the case where the first electrode layer 1014 is a silver layer, for example, one or more layers of silver paste may be coated on the other side of the acoustic layer 1013 to form the first electrode layer 1014.

The ultrasonic sensor 101 further includes the protective layer 1015 that is covered on the other side of the first electrode layer 1014. The protective layer 1015 may prevent oxidation of the first electrode layer 1014 (e.g., a silver layer formed by the silver paste) or prevent degradation of the performance of the acoustic layer 1013, and the protective layer 1015 may also serve as an insulating layer to prevent short circuits between the first electrode layer 1014 and other structures.

The acoustic layer 1013 may emit an ultrasonic signal and receive an ultrasonic signal reflected by the external structure. In an example application scenario, the external structure may be a user's finger (referring to the example shown in FIG. 7, the finger is represented by a symbol 300), and the fingerprint module 100 may be used for under-screen fingerprint recognition. After the user touches a specific area on the screen with the finger, the acoustic layer 1013 of the ultrasonic sensor 101 in the fingerprint module 100 emits an ultrasonic signal, and the user's finger reflects at least part of the ultrasonic signal, and the acoustic layer 1013 receives the ultrasonic signal reflected back by the user's finger.

The ultrasonic sensor 101 may process the ultrasonic signal received by the acoustic layer 1013 into an electrical signal. Alternatively, an ultrasonic signal processing circuit may be formed on the substrate 1011 in the ultrasonic sensor 101, and the ultrasonic signal processing circuit may process the received ultrasonic signal into an electrical signal. After the ultrasonic sensor 101 processes the received ultrasonic signal into the electrical signal, the electrical signal may be sent to the processing unit external to the fingerprint module 100 via the circuit board 102 to enable the processing unit to perform fingerprint recognition based on the electrical signal.

The conductive adhesive layer 103 may be any conductive adhesive layer 103 structure, e.g., may be a conductive adhesive. In some alternative embodiments, the conductive adhesive layer 103 may be an Anisotropic Conductive Film (ACF). The anisotropic conductive film has the property of being perpendicularly conductive and parallelly non-conductive. Via the anisotropic conductive film (i.e., the conductive adhesive layer 103), the first electrical connection region 1016 of the ultrasonic sensor 101 may be reliably electrically connected to the second electrical connection region 1021 on the circuit board 102, and the first electrical connection region 1016 and the second electrical connection region 1021 may be electrically connected by means of lamination, which simplifies the complexity of manufacturing of the fingerprint module 100, and can more conveniently meet application requirements. Alternatively, the anisotropic conductive film has a thickness of 1-5 μm after being laminated by the first electrical connection region 1016 and the second electrical connection region 1021.

Alternatively, as shown in FIG. 1, after the first electrical connection region 1016 and the second electrical connection region 1021 are electrically connected via the conductive adhesive layer 103 (e.g., the anisotropic conductive film), a protective adhesive (e.g., the protective adhesive 105 as shown in FIG. 9, FIG. 11, FIG. 13 and FIG. 15) may be covered on a side of the conductive adhesive layer 103 that extends beyond the substrate, and the protective adhesive is in contact with at least the substrate 1011, the conductive adhesive layer 103, and the circuit board 102.

Since the protective adhesive is provided, the portion of the conductive adhesive layer 103 extending beyond the substrate 1011 may be protected, preventing damage to the portion of the conductive adhesive layer 103 extending beyond the substrate 1011, and also preventing the same portion of the conductive adhesive layer 103 from being exposed to the outside and resulting in short-circuits. In addition, since the protective adhesive is in contact with the substrate 1011 and the circuit board 102 (e.g., as shown in FIG. 9, FIG. 11, FIG. 13, and FIG. 15), the circuit board 102 may be prevented from detaching from the ultrasonic sensor 101, thus enhancing stability.

The fingerprint module 100 may be mounted on an electronic device during use. In the embodiments of the present disclosure, the type of the electronic device is not limited, and the electronic device may include but is not limited to mobile phones, tablet computers, or other electronic devices requiring a fingerprint recognition function. The processing unit may be any processing unit external to the fingerprint module 100. Alternatively, the processing unit may be a processing unit in the electronic device. The electronic device in the present disclosure will be described in detail below, detailed description thereof will be omitted herein.

In an embodiment of the present disclosure, the fingerprint module 100 includes the ultrasonic sensor 101 and the circuit board 102. The ultrasonic sensor 101 includes the acoustic layer 1013, the substrate 1011, the first electrode layer 1014, and the protective layer 1015. The acoustic layer 1013 may emit and receive the reflected ultrasonic signal, and the ultrasonic sensor 101 may convert the ultrasonic signal received by the acoustic layer 1013 into an electrical signal, which is then transmitted by the circuit board 102 to the processing unit external to the fingerprint module 100, thereby accomplishing ultrasonic fingerprint recognition. Since the present disclosure uses ultrasonic waves for fingerprint recognition in real time, it may be applied to electronic devices with low optical transmittance, compared to optical fingerprint recognition, and since the sum of thicknesses of the acoustic layer 1013, the first electrode layer 1014, and the protective layer 1015 ranges from 48 μm to 60 μm, and the thickness of the substrate 1011 ranges from 125 μm to 155 μm, the thickness of the entire ultrasonic sensor 101 may be kept below 0.22 mm. Compared to conventional ultrasonic sensors 101 manufactured using the thin-film transistor process, the ultrasonic sensor 101 in the present disclosure may be applied to electronic devices having high space utilization requirements but thick in thickness (e.g., secondary screens of foldable smartphones, non-foldable smartphones with thick profiles, etc.). Therefore, the fingerprint module 100 is highly applicable and can meet the application requirements of the electronic device.

In a possible implementation, the sum of thicknesses of the acoustic layer 1013, the first electrode layer 1014, and the protective layer 1015 is 54 μm, the thickness of the substrate 1011 is 150 μm, and the frequency of the ultrasonic signal emitted by the acoustic layer 1013 is 8 MHz.

In an embodiment of the present disclosure, the sum of thicknesses of the acoustic layer 1013, the first electrode layer 1014, and the protective layer 1015 is 54 μm, and the thickness of the substrate 1011 is 150 μm, thereby achieving a balance between the performance and thickness of the ultrasonic sensor 101, and maintaining the minimum thickness with low performance degradation. In addition, the frequency of the ultrasonic signal emitted by the acoustic layer 1013 is 8 MHz, which may be matched with the thickness to enable ultrasonic waves to penetrate the ultrasonic sensor 101 of that thickness and the electronic device, may be applied to electronic devices having high space utilization requirements but thick in thickness (e.g., secondary screens of foldable smartphones, non-foldable smartphones with thick profiles, etc.). Therefore, the fingerprint module 100 is highly applicable and can meet the application requirements of the electronic device.

In a possible implementation, as shown in FIG. 1, a fingerprint module 100 includes: an ultrasonic sensor 101 and a circuit board 102.

The ultrasonic sensor 101 includes a substrate 1011, an acoustic layer 1013, a first electrode layer 1014, and a protective layer 1015, the substrate 1011 is provided with a second electrode layer 1012, one side of the acoustic layer 1013 is electrically connected to the second electrode layer 1012, the other side of the acoustic layer 1013 is electrically connected to one side of the first electrode layer 1014, and the protective layer 1015 is covered on the other side of the first electrode layer 1014, where a sum of thicknesses of the acoustic layer 1013, the first electrode layer 1014, and the protective layer 1015 ranges from 44 μm to 50 μm, and a thickness of the substrate 1011 ranges from 85 μm to 115 μm. The substrate 1011 is provided with a first electrical connection region 1016, the first electrode layer 1014 and the second electrode layer 1012 are electrically connected to the first electrical connection region 1016, respectively, the circuit board 102 is provided with a second electrical connection region 1021, and the first electrical connection region 1016 and the second electrical connection region 1021 are electrically connected via a conductive adhesive layer 103.

The circuit board 102 is electrically connected to a processing unit external to the fingerprint module 100, the acoustic layer 1013 is configured to emit an ultrasonic signal and receive an ultrasonic signal reflected by an external structure, the ultrasonic sensor 101 is configured to convert the ultrasonic signal received by the acoustic layer 1013 into an electrical signal and send the electrical signal to the processing unit via the circuit board 102 to enable the processing unit to perform fingerprint recognition based on the electrical signal, where a frequency of the ultrasonic signal emitted by the acoustic layer 1013 ranges from 9 MHz to 11 MHz.

The substrate 1011 of the ultrasonic sensor 101 is a silicon substrate, the substrate 1011 is provided with the second electrode layer 1012, and the second electrode layer 1012 and the substrate 1011 may be integrally molded, e.g., the second electrode layer 1012 may be a transistor formed on the silicon substrate, and the second electrode layer 1012 may also be a metal plate provided on the substrate 1011. One side of the acoustic layer 1013 is electrically connected to the second electrode layer 1012, the other side of the acoustic layer 1013 is electrically connected to the first electrode layer 1014, and the first electrode layer 1014 may be a conductive metal layer, e.g., a conductive metal layer such as a silver layer or a copper layer. Alternatively, in the case where the first electrode layer 1014 is a silver layer, for example, one or more layers of silver paste may be coated on the other side of the acoustic layer 1013 to form the first electrode layer 1014.

The ultrasonic sensor 101 further includes the protective layer 1015 that is covered on the other side of the first electrode layer 1014. The protective layer 1015 may prevent oxidation of the first electrode layer 1014 (e.g., a silver layer formed by the silver paste) or prevent degradation of the performance of the acoustic layer 1013, and the protective layer 1015 may also serve as an insulating layer to prevent short circuits between the first electrode layer 1014 and other structures.

The acoustic layer 1013 may emit an ultrasonic signal and receive an ultrasonic signal reflected by the external structure. In an example application scenario, the external structure may be a user's finger (referring to the example shown in FIG. 7, the finger is represented by a symbol 300), and the fingerprint module 100 may be used for under-screen fingerprint recognition. After the user touches a specific area on the screen with the finger, the acoustic layer 1013 of the ultrasonic sensor 101 in the fingerprint module 100 emits an ultrasonic signal, and the user's finger reflects at least part of the ultrasonic signal, and the acoustic layer 1013 receives the ultrasonic signal reflected back by the user's finger.

The ultrasonic sensor 101 may process the ultrasonic signal received by the acoustic layer 1013 into an electrical signal. Alternatively, an ultrasonic signal processing circuit may be formed on the substrate 1011 in the ultrasonic sensor 101, and the ultrasonic signal processing circuit may process the received ultrasonic signal into an electrical signal. After the ultrasonic sensor 101 processes the received ultrasonic signal into the electrical signal, the electrical signal may be sent to the processing unit external to the fingerprint module 100 via the circuit board 102 to enable the processing unit to perform fingerprint recognition based on the electrical signal.

The conductive adhesive layer 103 may be any conductive adhesive layer 103 structure, e.g., may be a conductive adhesive. In some alternative embodiments, the conductive adhesive layer 103 may be an Anisotropic Conductive Film (ACF). The anisotropic conductive film has the property of being perpendicularly conductive and parallelly non-conductive. Via the anisotropic conductive film (i.e., the conductive adhesive layer 103), the first electrical connection region 1016 of the ultrasonic sensor 101 may be reliably electrically connected to the second electrical connection region 1021 on the circuit board 102, and the first electrical connection region 1016 and the second electrical connection region 1021 may be electrically connected by means of lamination, which simplifies the complexity of manufacturing of the fingerprint module 100, and can more conveniently meet application requirements. Alternatively, the anisotropic conductive film has a thickness of 1-5 μm after being laminated by the first electrical connection region 1016 and the second electrical connection region 1021.

Alternatively, as shown in FIG. 1, after the first electrical connection region 1016 and the second electrical connection region 1021 are electrically connected via the conductive adhesive layer 103 (e.g., the anisotropic conductive film), a protective adhesive (e.g., the protective adhesive 105 as shown in FIG. 9, FIG. 11, FIG. 13 and FIG. 15) may be covered on a side of the conductive adhesive layer 103 that extends beyond the substrate, and the protective adhesive is in contact with at least the substrate 1011, the conductive adhesive layer 103, and the circuit board 102.

Since the protective adhesive is provided, the portion of the conductive adhesive layer 103 extending beyond the substrate 1011 may be protected, preventing damage to the portion of the conductive adhesive layer 103 extending beyond the substrate 1011, and also preventing the same portion of the conductive adhesive layer 103 from being exposed to the outside and resulting in short-circuits. In addition, since the protective adhesive is in contact with the substrate 1011 and the circuit board 102 (e.g., as shown in FIG. 9, FIG. 11, FIG. 13, and FIG. 15), the circuit board 102 may be prevented from detaching from the ultrasonic sensor 101, thus enhancing stability.

The fingerprint module 100 may be mounted on an electronic device during use. In the embodiments of the present disclosure, the type of the electronic device is not limited, and the electronic device may include but is not limited to mobile phones, tablet computers, or other electronic devices requiring a fingerprint recognition function. The processing unit may be any processing unit external to the fingerprint module 100. Alternatively, the processing unit may be a processing unit in the electronic device. The electronic device in the present disclosure will be described in detail below, detailed description thereof will be omitted herein.

In an embodiment of the present disclosure, the fingerprint module 100 includes the ultrasonic sensor 101 and the circuit board 102. The ultrasonic sensor 101 includes the acoustic layer 1013, the substrate 1011, the first electrode layer 1014, and the protective layer 1015. The acoustic layer 1013 may emit and receive the reflected ultrasonic signal, and the ultrasonic sensor 101 may convert the ultrasonic signal received by the acoustic layer 1013 into an electrical signal, which is then transmitted by the circuit board 102 to the processing unit external to the fingerprint module 100, thereby accomplishing ultrasonic fingerprint recognition. Since the present disclosure uses ultrasonic waves for fingerprint recognition in real time, it may be applied to electronic devices with low optical transmittance, compared to optical fingerprint recognition, and since the sum of thicknesses of the acoustic layer 1013, the first electrode layer 1014, and the protective layer 1015 ranges from 44 μm to 50 μm, and the thickness of the substrate 1011 ranges from 85 μm to 115 μm, the thickness of the entire ultrasonic sensor 101 may be kept below 0.17 mm. Compared to conventional ultrasonic sensors 101 manufactured using the thin-film transistor process, the ultrasonic sensor 101 in the present disclosure may be applied to electronic devices having high space utilization requirements (e.g., mobile phones, tablet computers, or other electronic devices requiring a fingerprint recognition function). Therefore, the fingerprint module 100 is highly applicable and can meet the application requirements of the electronic device.

In a possible implementation, the sum of thicknesses of the acoustic layer 1013, the first electrode layer 1014, and the protective layer 1015 is 47 μm, the thickness of the substrate 1011 is 90 μm, and the frequency of the ultrasonic signal emitted by the acoustic layer 1013 is 10 MHz.

In an embodiment of the present disclosure, the sum of thicknesses of the acoustic layer 1013, the first electrode layer 1014, and the protective layer 1015 is 40 μm, and the thickness of the substrate 1011 is 90 μm, thereby achieving a balance between the performance and thickness of the ultrasonic sensor 101, and maintaining the minimum thickness with low performance degradation. In addition, the frequency of the ultrasonic signal emitted by the acoustic layer 1013 is 10 MHz, which may be matched with the thickness to enable ultrasonic waves to penetrate the ultrasonic sensor 101 of that thickness and the electronic device, may be applied to electronic devices having high space utilization requirements (e.g., mobile phones, tablet computers, or other electronic devices requiring a fingerprint recognition function). Therefore, the fingerprint module 100 is highly applicable and can meet the application requirements of the electronic device.

The following describes the structure of the fingerprint module. It should be noted that the following description of the structure of the fingerprint module applies to the fingerprint module 10 in any one of the aforementioned embodiments.

FIG. 2 is a schematic diagram of a substrate of an ultrasonic sensor provided in an embodiment of the present disclosure. As shown in FIG. 2, the second electrode layer 1012 includes a plurality of complementary metal oxide semiconductors 10111 formed on the substrate 1011, and at least some of the plurality of complementary metal oxide semiconductors 10111 are electrically connected to one side of the acoustic layer 1013. The first electrode layer 1014 and the second electrode layer 1012 may be configured to provide the acoustic layer 1013 with voltages required for emitting and receiving the ultrasonic signals.

The substrate 1011 includes a plurality of Complementary Metal Oxide Semiconductors (CMOS) 10111. At least some of the plurality of CMOSs are arranged in a matrix pattern to form the second electrode layer 1012. A voltage difference may be formed between the second electrode layer 1012 and the first electrode layer 1014, thereby enabling power supply to the acoustic layer 1013. When performing fingerprint recognition, each CMOS functions as a “pixel.” After the acoustic layer 1013 receives the ultrasonic signal reflected back by the external structure (e.g., a finger), voltage signals converted on each CMOS vary depending on the different intensity of the ultrasonic signal. The ultrasonic signal processing circuit of the ultrasonic sensor 101 calculates the voltage signal of each CMOS using an algorithm and sends the voltage signals to the processing unit. Then, the processing unit processes the voltage signals to output a fingerprint image for fingerprint recognition.

In an example, as shown in FIG. 2, the substrate 1011 includes a recognition area AA and a non-recognition area NAA. The recognition area AA is an area on the ultrasonic sensor 101 where fingerprint identification can be performed, at least part of the acoustic layer 1013 is located within the recognition area AA, and the second electrode layer 1012 is formed by at least some of the CMOSs located in the recognition area AA. The non-recognition area NAA is an area on the ultrasonic sensor 101 where fingerprint recognition cannot be performed, including all areas except the recognition area AA. The non-recognition area NAA may be used to accommodate some other components of the ultrasonic sensor 101, such as the first electrical connection region 1016. In the present disclosure, the size of the recognition area AA is not limited, as long as it meets the requirements.

Alternatively, the first electrode layer 1014 may be electrically connected to a grounding circuit on the circuit board 102 via the first electrical connection region 1016, thereby allowing the first electrode layer 1014 to serve as a cathode layer for grounding. The second electrode layer 1012 may serve as an anode layer. Upon receiving an external pressing (e.g., pressed by a finger when performing fingerprint recognition), a voltage difference may be formed between the second electrode layer 1012 and the first electrode layer 1014. In this regard, power may be supplied to the acoustic layer 1013 to provide the acoustic layer 1013 with the voltages required for emitting and receiving the ultrasonic signals.

In an example, the acoustic layer 1013 in the present disclosure may include a piezoelectric material. A voltage may be provided to the piezoelectric material of the acoustic layer 1013 via the first electrode layer 1014 and the second electrode layer 1012. Based on a piezoelectric effect of the piezoelectric material, the acoustic layer 1013 may emit an ultrasonic signal and receive an ultrasonic signal reflected back by the external structure. Alternatively, the piezoelectric material of the acoustic layer 1013 may be a film layer, which may be manufactured using a coating process. The present disclosure does not impose any restrictions on the piezoelectric material. For example, the piezoelectric material may be a polyvinylidene fluoride (PVDF) material, which includes but is not limited to PVDF and its copolymers. Based on this, the acoustic layer 1013 in the present disclosure includes a PVDF material layer, which may effectively meet the requirements for emitting an ultrasonic signal and receiving an ultrasonic signal reflected back by the external structure.

In an embodiment of the present disclosure, the second electrode layer 1012 includes a plurality of CMOSs formed on the substrate 1011, thereby enabling power supply to the acoustic layer 1013 via the second electrode layer 1012 and the first electrode layer 1014. In addition, since the ultrasonic sensor 101 is a CMOS ultrasonic sensor 101, compared to ultrasonic sensors 101 manufactured using the thin-film transistor process, the CMOS ultrasonic sensor 101 has higher pixel integration, higher stability, and superior driving performance. Moreover, the CMOS ultrasonic sensor 101 is manufactured based on the CMOS process, thus having a smaller size, and since the second electrode layer 1012 is formed as a plurality of CMOSs on the substrate 1011, there is no need to separately configure the second electrode layer 1012, thus enabling a thin profile. Therefore, the application requirements of the electronic device for both performance and space may be simultaneously met.

In a possible implementation, as shown in FIG. 1 and FIG. 2, the first electrical connection region 1016 and the second electrode layer 1012 are located on the same side of the substrate 1011.

In an embodiment of the present disclosure, the first electrical connection region 1016 and the second electrode layer 1012 are located on the same side of the substrate 1011, thereby enabling the second electrode layer 1012 formed on the substrate 1011 to be electrically connected to the first electrical connection region 1016 without the need for complex wiring, and allowing the first electrical connection region 1016 and the first electrode layer 1014 to be electrically connected. Since there is no need for complex wiring, the forming process of the ultrasonic sensor 101 may be simpler.

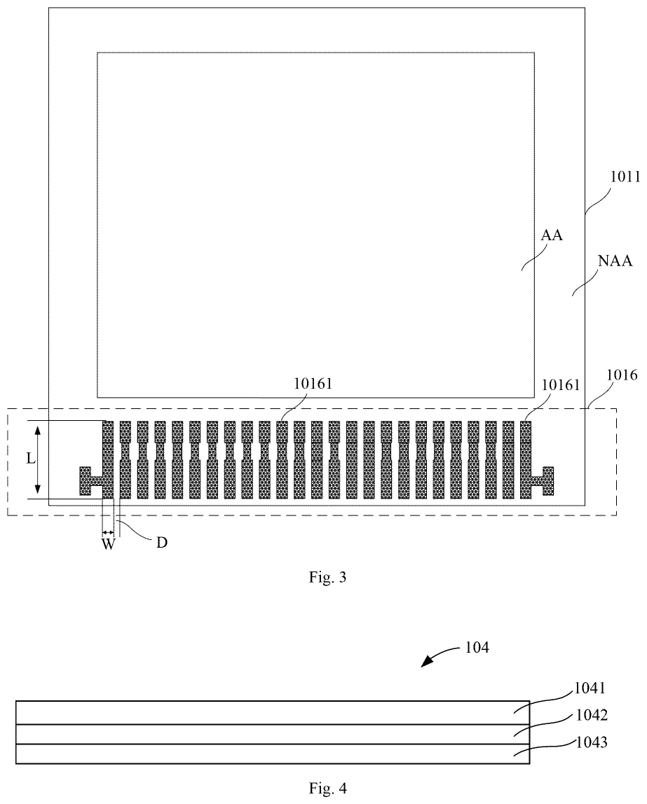

FIG. 3 is a schematic diagram of a first electrical connection region provided in an embodiment of the present disclosure. As shown in FIG. 3, the first electrical connection region 1016 includes a plurality of pins 10161 arranged side by side, each of the plurality of pins 10161 has a width W of 0.09 mm, a length L of the pin 10161 ranges from 0.3 mm to 0.385 mm, and a distance N between two adjacent pins 10161 is 0.07 mm, at least some of the plurality of pins 10161 are electrically connected to the second electrical connection region 1021.

Alternatively, a passivation layer may be formed on the substrate 1011 of the ultrasonic sensor 101. In the present disclosure, method 1 or method 2 may be used to manufacture the first electrical connection region 1016:

Method 1: A layer of RDL (Redistribution Layer) lines may be manufactured on a surface of the passivation layer of the substrate 1011 of the ultrasonic sensor 101 using RDL process. One end of the RDL lines is electrically connected to a lead-out position of the ultrasonic sensor 101 where requires a lead-out. The RDL lines may form the pins 10161 of the first electrical connection region 1016.

Method 2: During chip design of the ultrasonic sensor 101, an area for forming the plurality of pins 10161 of the first electrical connection region 1016 may be pre-added below the lead-out position of the ultrasonic sensor 101, and a window may be opened on the passivation layer surface of the substrate 1011 of ultrasonic sensor 101 to expose this area. Subsequently, a conductive layer of appropriate thickness may be formed on the area (the method of forming the conductive layer is not limited herein, such as by Au plating) to form the pins 10161 of the first electrical connection region 1016.

Both of these two methods may be used to manufacture the first electrical connection region 1016 including the plurality of pins 10161, which may be selected as needed and is not limited herein. Of course, other methods may also be used to manufacture the first electrical connection region 1016 including the plurality of pins 10161, which is not limited herein.

Alternatively, a surface of the pin 10161, i.e., a connection side of the pin 10161 with the conductive adhesive layer 103, may be provided with a conductive plating layer, which may be formed as a conductive film. Due to the influence of certain manufacturing processes during manufacturing the pin 10161, the pin 10161 may exhibit a certain degree of concavity (e.g., 1 μm to 2 μm). Therefore, in the present disclosure, an additional conductive plating layer is set on the pin 10161, which helps protect the pin 10161 and raises the concave portion of the pin 10161, making it easier to meet the requirements of the pin 10161 for electrical connection via the conductive adhesive layer 103 (e.g., ACF).

The present disclosure does not limit the material of the conductive plating layer, as long as it meets the requirements. Alternatively, the conductive plating layer may include at least one of the following: an ITO (Indium Tin Oxides) plating layer, a Ti plating layer (i.e., titanium plating layer), a Ni plating layer (i.e., nickel plating layer), an Ag plating layer (i.e., silver plating layer), or an Au plating layer (i.e., gold plating layer).

In an embodiment of the present disclosure, the first electrical connection region 1016 includes a plurality of pins 10161, each pin 10161 has a width W of 0.09 mm, the length L of the pin 10161 ranges from 0.3 mm to 0.385 mm, and the distance N between two adjacent pins 10161 is 0.07 mm. Thus, the first electrical connection region 1016 and the second electrical connection region 1021 are electrically connected, and the adjacent pins 10161 in an embodiment of the present disclosure have a certain distance N therebetween, which may improve a heat dissipation function of the pins 10161 and prevent the first electrical connection region 1016 from overheating.

In a possible implementation, the fingerprint module 100 further includes: an adhesive layer 104. FIG. 4 is a schematic diagram of an adhesive layer provided in an embodiment of the present disclosure. As shown in FIG. 4, the adhesive layer 104 includes a first double-sided adhesive 1041, a first copper foil layer 1042 and a second double-sided adhesive 1043, one side of the first copper foil layer 1042 is adhered to one side of the first double-sided adhesive 1041, the other side of the first copper foil layer 1042 is adhered to one side of the second double-sided adhesive 1043, the other side of the second double-sided adhesive 1043 is adhesively bonded to the substrate 1011, and the second double-sided adhesive 1043 and the acoustic layer 1013 are located on two sides of the substrate 1011, respectively. The other side of the first double-sided adhesive 1041 may be adhesively bonded to an electronic device external to the fingerprint module 100.

In an embodiment of the present disclosure, the fingerprint module 100 further includes the adhesive layer 104, which may be configured to adhesively bond the fingerprint module 100 to an electronic device. Since the adhesive layer 104 includes the first double-sided adhesive 1041, the first copper foil layer 1042, and the second double-sided adhesive 1043, the adhesive layer 104 has high strength and may serve as a buffer and insulator between the fingerprint module 100 and the external electronic device.

In a possible implementation, in the adhesive layer 104, the first double-sided adhesive 1041 has a thickness of 6 μm, the first copper foil layer 1042 has a thickness of 6 μm, and the second double-sided adhesive 1043 has a thickness of 3 μm; or the first double-sided adhesive 1041 has a thickness of 6 μm, the first copper foil layer 1042 has a thickness of 35 μm, and the second double-sided adhesive 1043 has a thickness of 6 μm; or the first double-sided adhesive 1041 has a thickness of 6 μm, the first copper foil layer 1042 has a thickness of 16 μm, and the second double-sided adhesive 1043 has a thickness of 6 μm.

In an embodiment of the present disclosure, the adhesive layer 104 may use double-sided adhesives of different thicknesses depending on the electronic device. For example, for an ultra-thin electronic device, the first double-sided adhesive 1041 having a thickness of 6 μm, the first copper foil layer 1042 having a thickness of 6 μm, and the second double-sided adhesive 1043 having a thickness of 3 μm may be used. This allows the fingerprint module 100 to be adhesively bonded to different electronic devices, meeting requirements for varying adhesive bonding thicknesses and strengths, thereby achieving high applicability.

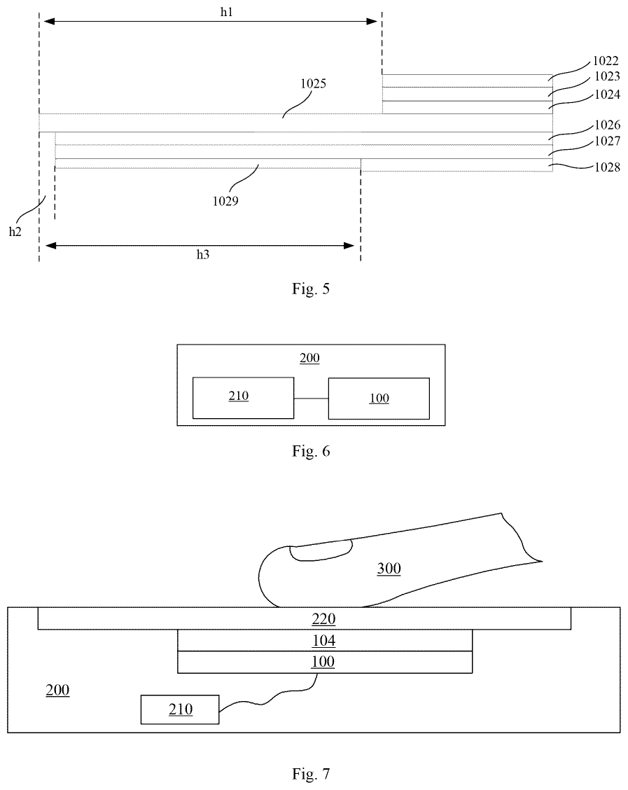

FIG. 5 is a schematic diagram of a circuit board provided in an embodiment of the present disclosure. As shown in FIG. 5, the circuit board 102 includes a flexible circuit board, and the flexible circuit board includes a first cover film 1022, a first electroless copper layer 1023, a second copper foil layer 1024, a substrate layer 1025, a third copper foil layer 1026, a second electroless copper layer 1027 and a second cover film 1028. One side of the first cover film 1022 is attached to one side of the first electroless copper layer 1023, the other side of the first electroless copper layer 1023 is attached to one side of the second copper foil layer 1024, the other side of the second copper foil layer 1024 is attached to one side of the substrate layer 1025, the other side of the substrate layer 1025 is attached to one side of the third copper foil layer 1026, the other side of the third copper foil layer 1026 is attached to one side of the second electroless copper layer 1027, and the other side of the second electroless copper layer 1027 is attached to one side of the second cover film 1028.

At one end of the circuit board 102, the first cover film 1022, the first electroless copper layer 1023, and the second copper foil layer 1024 are indented by a first distance h1 relative to the substrate layer 1025, the third copper foil layer 1026 and the second electroless copper layer 1027 are indented by a second distance h2 relative to the substrate layer 1025, the second cover film 1028 is indented by a third distance h3 relative to the substrate layer 1025, the first distance h1 is greater than the second distance h2, and the third distance h3 is greater than the second distance h2, where the second cover film 1028 is indented relative to the third copper foil layer 1026 and the second electroless copper layer 1027 to form the second electrical connection region 1021.

Alternatively, as shown in FIG. 5, an electroless nickel immersion gold (ENIG) process may be performed on the second electrical connection region 1021 formed by indenting the second cover film 1028 relative to the third copper foil layer 1026 and the second electroless copper layer 1027, to form an electroplated layer 1029 on the exposed second electroless copper layer 1027, thereby preventing the exposed second electroless copper layer 1027 from rusting and corroding.

In an embodiment of the present disclosure, the circuit board 102 may include the flexible circuit board 102, thereby allowing the circuit board 102 to be bent when connected to ensure space requirements of the electronic device. The first cover film 1022, the first electroless copper layer 1023, and the second copper foil layer 1024 are indented by the first distance h1 relative to the substrate layer 1025, which may improve reliability of the flexible circuit board 102. The third copper foil layer 1026 and the second electroless copper layer 1027 are indented by the second distance h2 relative to the substrate layer 1025, thereby ensuring that edges of the circuit board 102 are smooth when cutting the circuit board 102. The second cover film 1028 is indented relative to the third copper foil layer 1026 and the second electroless copper layer 1027 to form the second electrical connection region 1021, which may enable the circuit board 102 to be electrically connected to the first electrical connection region 1016 via the conductive adhesive layer 103, thereby improving electrical conductivity.

FIG. 6 is a schematic diagram of an electronic device provided in an embodiment of the present disclosure. As shown in FIG. 6, an electronic device 200 includes: a processing unit 210, and the fingerprint module 100 according to any one of the above embodiments. Specifically, the processing unit 210 may be the “processing unit external to the fingerprint module 100” described in the aforementioned embodiments of the fingerprint module 100. The processing unit 210 and the circuit board in the fingerprint module 100 are electrically connected. The processing unit 210 may receive the electrical signal sent by the ultrasonic sensor in the fingerprint module 100 via the circuit board and perform fingerprint recognition based on the electrical signal. The processing unit 210 may include at least one chip capable of data processing, such as a CPU, GPU, MCU, DSP, or FPGA.

Alternatively, in the present disclosure, when performing fingerprint recognition based on the electrical signal, the processing unit 210 may process the electrical signal using an image processing circuit and/or an image processing algorithm to generate a fingerprint image, and then compare the fingerprint image with pre-stored fingerprint images to implement the fingerprint recognition function.

In the present disclosure, the type of the electronic device 200 is not limited, and the electronic device 200 may include but is not limited to mobile phones, tablet computers, or other electronic devices requiring a fingerprint recognition function, such as fingerprint locks.

In an embodiment of the present disclosure, a set position of the fingerprint module 100 on the electronic device 200 is not limited, and the fingerprint module 100 may be positioned at any suitable location as needed. Alternatively, the electronic device 200 may include a screen 220, and the fingerprint module 100 may be provided at a back side of the screen 220. By providing the fingerprint module 100 at the back side of the screen 220, the present disclosure may implement the under-screen fingerprint recognition function. For example, the under-screen fingerprint recognition function may be used for functions such as under-screen fingerprint unlocking function, or under-screen fingerprint payment function of the electronic device 200 (including but not limited to mobile phones). The screen 220 in the present disclosure may be any type of screen, including but not limited to LCD screens, LED screens, OLED screens, etc. The screen 220 may be a non-foldable screen or a foldable screen, which is not limited herein.

FIG. 7 is a schematic diagram of a specific application scenario of a fingerprint module provided in an embodiment of the present disclosure. As shown in FIG. 7, a user may use a finger 300 to enter fingerprint in a specific area on the front side of the screen 220.

The present disclosure also does not limit the mounting method of the fingerprint module 100 under the screen 220. For example, as shown in FIG. 7, the fingerprint module 100 may be adhesively bonded to the back side of the screen 220 via the adhesive layer 104. In the present disclosure, the adhesive layer 104 may ensure that the fingerprint module 100 is adhesively bonded to the back side of the screen 220, maintaining mounting stability of the fingerprint module 100 on the electronic device 200 and facilitating the use of the fingerprint module 100's functions by the electronic device 200.

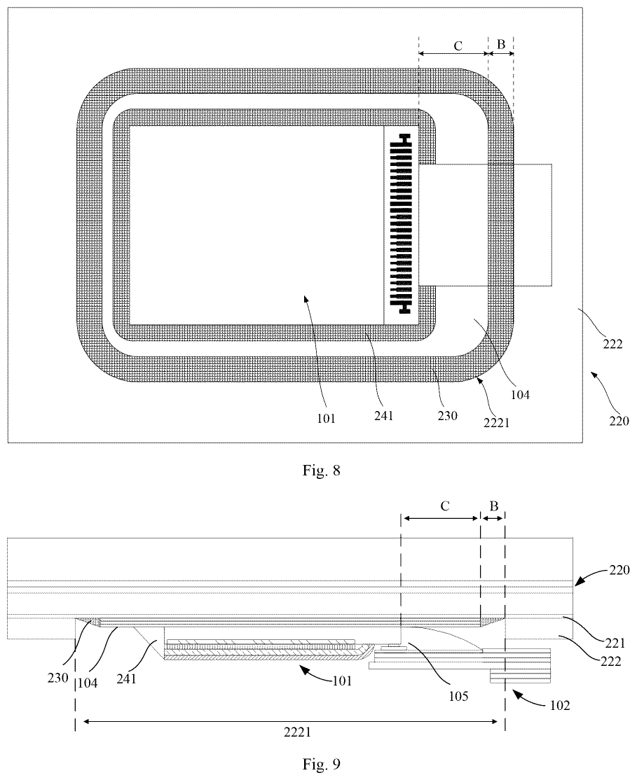

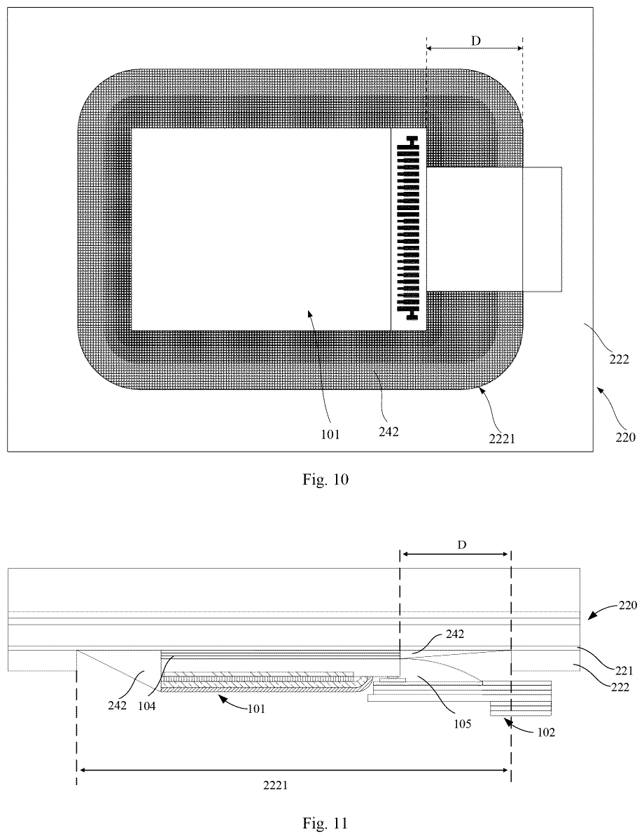

In a possible implementation, referring to FIG. 8 and FIG. 9, FIG. 10 and FIG. 11, for the electronic device 200, if the screen 220 is a non-foldable screen, the screen 220 includes a screen substrate 221 and a buffer layer 222, the buffer layer 222 is mounted on the screen substrate 221, and the buffer layer 222 is configured to buffer the screen 220; and the buffer layer 222 is provided with a first through-hole 2221, the substrate of the ultrasonic sensor passes through the first through-hole 2221 and is adhesively bonded to the screen substrate 221, and the fingerprint module 100 is adhesively bonded onto the screen substrate 221 via the adhesive layer 104.

In particular, the buffer layer 222 and the screen substrate 221 may form the back side of the screen 220. The buffer layer 222 buffers the screen 220 (non-foldable screen). The characteristics of the non-foldable screen require the buffering effect of the buffer layer 222 to reduce the impact on the screen 220. The buffer layer 222 is typically made of an elastic structure. It should be understood that for different screens 220, the buffer layer 222 may select different structures, which is not limited in the present disclosure. For example, in some embodiments, the buffer layer 222 may include foam, etc.

Alternatively, the buffer layer 222 may have the same or similar color as the aforementioned first double-sided adhesive 1041 of the adhesive layer 104, thereby improving a visual appearance of the electronic device 200 when the first through-hole 2221 is provided in the buffer layer 222, making the overall appearance more aesthetically pleasing. Additionally, and alternatively, the aforementioned first double-sided adhesive 1041 (i.e., screen-side double-sided adhesive) may be black, so that the adhesive layer 104 can serve as a light-shielding layer, which may effectively mitigate the issue of poor screen display quality caused by the first through-hole 2221 provided in the buffer layer 222.

In an embodiment of the present disclosure, the first through-hole 2221 is provided in the buffer layer 222 for buffering the screen 220, exposing a portion of the screen substrate 221 through the first through-hole 2221. The adhesive layer 104 adhesively bonds the substrate of the ultrasonic sensor to the exposed portion of the screen substrate 221 through the first through-hole 2221, which may reduce the obstruction and absorption effect of the buffer layer 222 on the ultrasonic signals sent and received by the ultrasonic sensor 101 of the fingerprint module 100, thereby improving a usage effect of the fingerprint module 100, and meeting the application requirements of the fingerprint module 100 in the electronic device 200 with a non-foldable screen.

Alternatively, for electronic devices with non-foldable screens, the adhesive layer 104 may select the first double-sided adhesive having a thickness of 6 μm, the first copper foil layer having a thickness of 6 μm, and the second double-sided adhesive having a thickness of 3 μm.

FIGS. 8-11 are schematic diagrams illustrating a connection relationship between a fingerprint module and a non-foldable screen provided in an embodiment of the present disclosure.

The size and shape of the first through-hole 2221 may be selected as needed, which is not limited in the present disclosure. As shown in FIG. 8 and FIG. 9, and FIG. 10 and FIG. 11, an outer contour of the first through-hole 2221 is larger than an outer contour of the adhesive layer 104, and also larger than an outer contour of the ultrasonic sensor 101 of the fingerprint module 100. In the example shown in FIG. 8 and FIG. 10, the shape of the first through-hole 2221 is a rounded rectangle, but this is merely an example, and the first through-hole 2221 may also be formed into regular shapes such as rectangle, circle, or regular polygon, or into irregular shapes.

In a possible implementation, in the electronic device 200, the screen 220 is a non-foldable screen, and the electronic device 200 further includes a first light-shielding structure 230 and a first fixing structure 241, where the first light-shielding structure 230 is configured to cover a gap formed between an edge of the adhesive layer 104 and an edge of the first through-hole 2221, and the first fixing structure 241 is configured to fix an edge of the ultrasonic sensor 101 onto the adhesive layer 104. For example, in some example embodiments, as shown in FIG. 8 and FIG. 9, in the electronic device 200, the screen 220 is a non-foldable screen, the gap B between the edge of the adhesive layer 104 and the edge of the first through-hole 2221 is >0.1 mm. Along a thickness direction of the acoustic layer 1013, a first vertical projection of the ultrasonic sensor 101 toward the adhesive layer 104 is located within the adhesive layer 104, and a gap C between an edge of the first vertical projection and the edge of the adhesive layer 104 is >0.5 mm. The electronic device 200 further includes the first light-shielding structure 230 and the first fixing structure 241, where the first light-shielding structure 230 is configured to cover the gap formed between the edge of the adhesive layer 104 and the edge of the first through-hole 2221, and the first fixing structure 241 is configured to fix the edge of the ultrasonic sensor 101 onto the adhesive layer 104.

In particular, when the gap B between the edge of the adhesive layer 104 and the edge of the first through-hole 2221 is >0.1 mm, in this regard, the outer contour of the adhesive layer 104 does not extend beyond the outer contour of the first through-hole 2221, as shown in FIG. 8 and FIG. 9, a portion of the screen substrate 221 of the screen 220 (non-foldable screen) may be exposed through the gap formed between the edge of the adhesive layer 104 and the edge of the first through-hole 2221, which may cause light leakage of the screen 220. Therefore, based on this structure in the present disclosure, on the one hand, the gap formed between the edge of the adhesive layer 104 and the edge of the first through-hole 2221 may be covered by the first light-shielding structure 230, thereby improving adverse effects caused by the light leakage of the screen 220 on a display performance of the screen 220 and the appearance of the electronic device 200. Along the thickness direction of the acoustic layer 1013, the first vertical projection of the ultrasonic sensor 101 toward the adhesive layer 104 is located within the adhesive layer 104. When the gap C between the edge of the first vertical projection and the edge of the adhesive layer 104 is >0.5 mm, the outer contour of the adhesive layer 104 extends beyond the outer contour of the ultrasonic sensor 101 excessively. Therefore, based on this structure in the present disclosure, on the other hand, the edge of the ultrasonic sensor 101 may be fixed onto the adhesive layer 104 via the first fixing structure 241, thereby enhancing the stability of the fingerprint module 100 when mounted on the electronic device 200; furthermore, based on this structure in the present disclosure, by fixing the edge of the ultrasonic sensor 101 onto the adhesive layer 104 via the first fixing structure 241, the fingerprint module 100 may be easily removed from the electronic device 200 without damaging the screen 220, and it also facilitates the remounting of the fingerprint module 100 onto the electronic device 200.

Alternatively, the first light-shielding structure 230 may adopt any suitable light-shielding structure, as long as it meets the requirements. For example, the first light-shielding structure 230 may include a light-shielding adhesive, which may be dispensed at the gap formed between the edge of the adhesive layer 104 and the edge of the first through-hole 2221, so that the cured light-shielding adhesive covers the gap and achieves the light-shielding function. Alternatively, a curing shrinkage rate of the light-shielding adhesive is less than 3%. When the curing shrinkage rate of the light-shielding adhesive is too high, it may exert a pulling force on the screen 220, resulting in poor display performance of the screen 220. In the present disclosure, a light-shielding adhesive having a curing shrinkage rate of less than 3% is selected as the first light-shielding structure 230, which may effectively avoid the problem of poor display performance of the screen 220 caused by the pulling force of the light-shielding adhesive on the screen 220. The present disclosure does not specify any particular type of the light-shielding adhesive; any adhesive that meets the requirements is acceptable. For example, the light-shielding adhesive may be at least one of UV-curable adhesion agent (such as UV adhesive, i.e., shadowless adhesive, which requires curing under ultraviolet light irradiation), UV and moisture-curable adhesion agent, or low-temperature (e.g., low temperature refers to below 100° C.) curable adhesion agent.

Alternatively, the first fixing structure 241 may adopt any suitable fixing structure, as long as it meets the requirements. For example, the first fixing structure 241 may include a fixing adhesive, which may be dispensed at the edge of the ultrasonic sensor 101 and the adhesive layer 104 to fix the edge of the ultrasonic sensor 101 onto the adhesive layer 104. Alternatively, a curing shrinkage rate of the fixing adhesive is less than 3%. When the curing shrinkage rate of the fixing adhesive is too high, it may exert a pulling force on the screen 220, resulting in poor display performance of the screen 220. In the present disclosure, a fixing adhesive having a curing shrinkage rate of less than 3% is selected as the first fixing structure 241, which may effectively avoid the problem of poor display performance of the screen 220 caused by the pulling force of the fixing adhesive on the screen 220. The present disclosure does not specify any particular type of the fixing adhesive; any adhesive that meets the requirements is acceptable. For example, the fixing adhesive may be at least one of UV-curable adhesion agent (such as UV adhesive, i.e., shadowless adhesive, which requires curing under ultraviolet light irradiation), UV and moisture-curable adhesion agent, or low-temperature (e.g., low temperature refers to below 100° C.) curable adhesion agent.

Therefore, in some embodiments of the present disclosure, by dispensing adhesive twice (i.e., the aforementioned light-shielding adhesive (i.e., the first light-shielding structure 230) and the fixing adhesive (i.e., the first fixing structure 241)), the fingerprint module 100 may be mounted between the screen 220 (non-foldable screen), thereby meeting both the light-shielding and module-fixing requirements.

Alternatively, in some other embodiments, in the electronic device 200, the screen 220 is a non-foldable screen, the electronic device 200 further includes a second fixing structure 242, and the second fixing structure 242 is configured to fix the edge of the ultrasonic sensor 101 onto the screen substrate 221.

For example, in some example embodiments, as shown in FIG. 10 and FIG. 11, in the electronic device 200, the screen 220 is a non-foldable screen, along the thickness direction of the acoustic layer 1013, a second vertical projection of the ultrasonic sensor 101 toward the screen substrate 221 is located within the first through-hole 2221, and a gap D between an edge of the second vertical projection and the edge of the first through-hole 2221 is >0.5 mm. Furthermore, the edge of the adhesive layer 104 does not extend beyond an edge of an adhesive bonding surface on the fingerprint module 100 that forms an adhesive bond with the adhesive layer 104. The electronic device 200 further includes the second fixing structure 242, and the second fixing structure 242 is configured to fix the edge of the ultrasonic sensor 101 onto the screen substrate 221.

In particular, along the thickness direction of the acoustic layer 1013, the second vertical projection of the ultrasonic sensor 101 toward the screen substrate 221 is located within the first through-hole 2221, the gap D between the edge of the second vertical projection and the edge of the first through-hole 2221 is >0.5 mm, and the edge of the adhesive layer 104 does not extend beyond the edge of the adhesive bonding surface on the fingerprint module 100 that forms an adhesive bond with the adhesive layer 104, in this regard, no separate light-shielding structure is provided in the present disclosure. Instead, the edge of the ultrasonic sensor 101 is directly fixed onto the screen substrate 221 by using the second fixing structure 242. Based on this structure, on the one hand, the edge of the ultrasonic sensor 101 may be fixed onto the screen substrate 221 via the second fixing structure 242, thereby enhancing the stability of the fingerprint module 100 when mounted on the electronic device 200; on the other hand, the second fixing structure 242 may also improve light leakage of the screen to some extent, achieving a light-shielding function, and improving the adverse effects caused by light leakage of the screen 220 on the display performance of the screen 220 and the appearance of the electronic device 200; furthermore, since a separate light-shielding structure is not required, a manufacturing process of the electronic device 200 is also simplified.

Alternatively, the second fixing structure 242 may adopt any suitable fixing structure, as long as it meets the requirements. For example, the second fixing structure 242 may include a fixing adhesive, which may be dispensed at the edge of the ultrasonic sensor 101 and the screen substrate 221 (e.g., the fixing adhesive may be dispensed at the edge of the first through-hole 2221), to fix the edge of the ultrasonic sensor 101 onto the screen substrate 221. Alternatively, a curing shrinkage rate of the fixing adhesive is less than 3%. When the curing shrinkage rate of the fixing adhesive is too high, it may exert a pulling force on the screen 220, resulting in poor display performance of the screen 220. In the present disclosure, a fixing adhesive having a curing shrinkage rate of less than 3% is selected as the second fixing structure 242, which may effectively avoid the problem of poor display performance of the screen 220 caused by the pulling force of the fixing adhesive on the screen 220. The present disclosure does not specify any particular type of the fixing adhesive; any adhesive that meets the requirements is acceptable. For example, the fixing adhesive may be at least one of UV-curable adhesion agent (such as UV adhesive, i.e., shadowless adhesive, which requires curing under ultraviolet light irradiation), UV and moisture-curable adhesion agent, or low-temperature (e.g., low temperature refers to below 100° C.) curable adhesion agent. Thus, in some embodiments of the present disclosure, the fingerprint module 100 may be mounted between the screen 220 (non-foldable screen) by dispensing adhesive once (i.e., the aforementioned fixing adhesive (i.e., the second fixing structure 242)), thereby meeting both the light-shielding and module-fixing requirements.

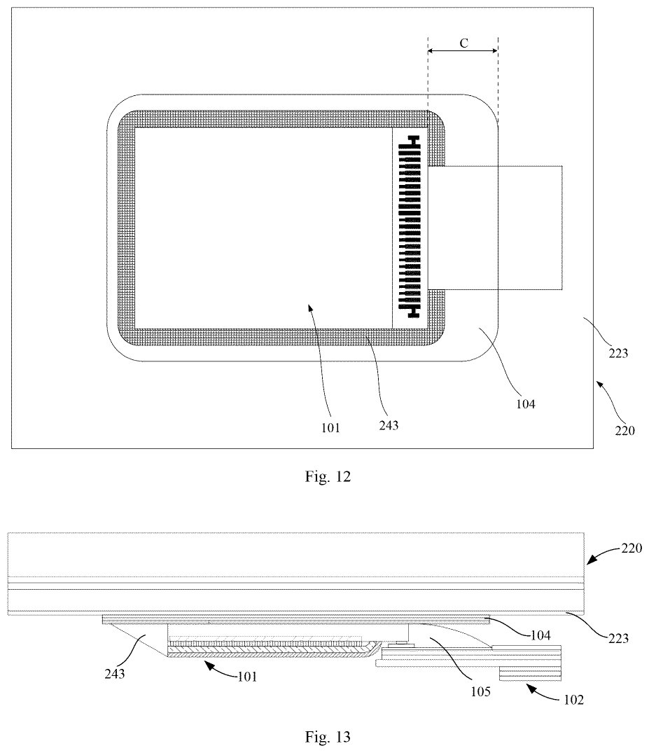

FIGS. 12-15 are schematic diagrams illustrating a connection relationship between a fingerprint module and a foldable screen provided in an embodiment of the present disclosure. In some alternative embodiments, as shown in FIGS. 12-15, for the electronic device 200, if the screen 220 is a foldable screen, the screen 220 includes a support sheet 223, and the support sheet 223 is configured to support the screen 220; and the fingerprint module 100 is adhesively bonded to the support sheet 223 via the adhesive layer 104.

In particular, the support sheet 223 may form the back side of the screen 220. The support sheet 223 supports the screen 220 (foldable screen). The characteristics of the foldable screen require a support effect of the support sheet 223 to enhance the stability of the screen 220. Foldable screens generally do not require a separate buffer layer, thus eliminating the issue of the buffer layer affecting the ultrasonic signals sent and received by the ultrasonic sensor 101 of the fingerprint module 100. The support sheet 223 is typically made of a malleable material with a certain strength, such as a metal material. For example, in some alternative embodiments, the support sheet 223 may be a support steel sheet, or in other embodiments, the support sheet 223 may also be a support copper sheet, etc. The present disclosure does not impose any specific restrictions herein. Of course, the support sheet 223 may also be made of other appropriate materials if the requirements are met.

Alternatively, for electronic devices with foldable screens, when the support sheet 223 is made of titanium alloy or other metal materials, the adhesive layer 104 may select the first double-sided adhesive having a thickness of 6 μm, the first copper foil layer having a thickness of 35 μm, and the second double-sided adhesive having a thickness of 6 μm. When the support sheet 223 is made of carbon fiber, the adhesive layer 104 may select the first double-sided adhesive having a thickness of 6 μm, the first copper foil layer having a thickness of 16 μm, and the second double-sided adhesive having a thickness of 6 μm.

In the present disclosure, by adhesively bonding the fingerprint module 100 to the support sheet 223, which is used to support the screen 220, via the adhesive layer 104, the fingerprint module 100 can be adhesively bonded to the back side of the screen 220 without affecting the fingerprint module 100's function of sending and receiving ultrasonic signals, thereby improving the usage effect of the fingerprint module 100, and meeting the application requirements of the fingerprint module 100 in the electronic device 200 with a foldable screen.

In some alternative embodiments, in the electronic device 200, the screen 220 is a foldable screen, the electronic device 200 further includes a third fixing structure 243, and the third fixing structure 243 is configured to fix the edge of the ultrasonic sensor 101 onto the adhesive layer 104. For example, in some example embodiments, as shown in FIG. 12 and FIG. 13, in the electronic device 200, the screen 220 is a foldable screen, along the thickness direction of the acoustic layer 1013, a first vertical projection of the ultrasonic sensor 101 toward the adhesive layer 104 is located within the adhesive layer 104, and a gap C between an edge of the first vertical projection and the edge of the adhesive layer 104 is >0.5 mm. The electronic device 200 further includes the third fixing structure 243, and the third fixing structure 243 is configured to fix the edge of the ultrasonic sensor 101 onto the adhesive layer 104.

In particular, along the thickness direction of the acoustic layer 1013, the first vertical projection of the ultrasonic sensor 101 toward the adhesive layer 104 is located within the adhesive layer 104. When the gap C between the edge of the first vertical projection and the edge of the adhesive layer 104 is >0.5 mm, the outer contour of the adhesive layer 104 extends beyond the outer contour of the ultrasonic sensor 101 excessively. Therefore, based on this structure in the present disclosure, on the one hand, the edge of the ultrasonic sensor 101 may be fixed onto the adhesive layer 104 via the third fixing structure 243, thereby enhancing the stability of the fingerprint module 100 when mounted on the electronic device 200; on the other hand, based on this structure in the present disclosure, by fixing the edge of the ultrasonic sensor 101 onto the adhesive layer 104 via the third fixing structure 243, the fingerprint module 100 may be easily removed from the electronic device 200 without damaging the screen 220, and it also facilitates the remounting of the fingerprint module 100 onto the electronic device 200.

Alternatively, the third fixing structure 243 may adopt any suitable fixing structure, as long as it meets the requirements. For example, the third fixing structure 243 may include a fixing adhesive, which may be dispensed at the edge of the ultrasonic sensor 101 and the adhesive layer 104 to fix the edge of the ultrasonic sensor 101 onto the adhesive layer 104. Alternatively, a curing shrinkage rate of the fixing adhesive is less than 3%. When the curing shrinkage rate of the fixing adhesive is too high, it may exert a pulling force on the screen 220, resulting in poor display performance of the screen 220. In the present disclosure, a fixing adhesive having a curing shrinkage rate of less than 3% is selected as the third fixing structure 243, which may effectively avoid the problem of poor display performance of the screen 220 caused by the pulling force of the fixing adhesive on the screen 220. The present disclosure does not specify any particular type of the fixing adhesive; any adhesive that meets the requirements is acceptable. For example, the fixing adhesive may be at least one of UV-curable adhesion agent (such as UV adhesive, i.e., shadowless adhesive, which requires curing under ultraviolet light irradiation), UV and moisture-curable adhesion agent, or low-temperature (e.g., low temperature refers to below 100° C.) curable adhesion agent.

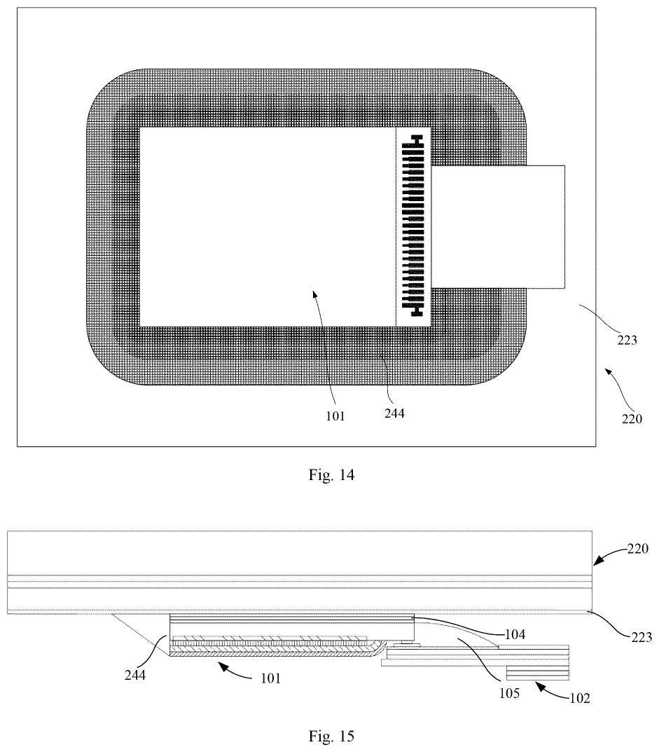

Therefore, in some embodiments of the present disclosure, the fingerprint module 100 may be mounted between the screen 220 (foldable screen) by dispensing adhesive once (i.e., the aforementioned fixing adhesive (i.e., the third fixing structure 243)), thereby meeting both the light-shielding and module-fixing requirements. Alternatively, in some other embodiments, in the electronic device 200, the screen 220 is a foldable screen, the electronic device 200 further includes a fourth fixing structure 244, and the fourth fixing structure 244 is configured to fix the edge of the ultrasonic sensor 101 onto the support sheet 223. For example, in some example embodiments, as shown in FIG. 14 and FIG. 15, in the electronic device 200, the screen 220 is a foldable screen, the edge of the adhesive layer 104 does not extend beyond an edge of an adhesive bonding surface on the fingerprint module 100 that forms an adhesive bond with the adhesive layer 104, i.e., the edge of the adhesive layer 104 does not extend beyond the edge of the ultrasonic sensor 101. The electronic device 200 further includes the fourth fixing structure 244, and the fourth fixing structure 244 is configured to fix the edge of the ultrasonic sensor 101 onto the support sheet 223.

In particular, the edge of the adhesive layer 104 does not extend beyond the edge of the adhesive bonding surface on the fingerprint module 100 that forms an adhesive bond with the adhesive layer 104, in the present disclosure, the edge of the ultrasonic sensor 101 may be fixed onto the support sheet 223 by using the fourth fixing structure 244, thereby enhancing the stability of the fingerprint module 100 when mounted on the electronic device 200.

Alternatively, the fourth fixing structure 244 may adopt any suitable fixing structure, as long as it meets the requirements. For example, the fourth fixing structure 244 may include a fixing adhesive, which may be dispensed at the edge of the ultrasonic sensor 101 and the support sheet 223, to fix the edge of the ultrasonic sensor 101 onto the support sheet 223. Alternatively, a curing shrinkage rate of the fixing adhesive is less than 3%. When the curing shrinkage rate of the fixing adhesive is too high, it may exert a pulling force on the screen 220, resulting in poor display performance of the screen 220. In the present disclosure, a fixing adhesive having a curing shrinkage rate of less than 3% is selected as the fourth fixing structure 244, which may effectively avoid the problem of poor display performance of the screen 220 caused by the pulling force of the fixing adhesive on the screen 220. The present disclosure does not specify any particular type of the fixing adhesive; any adhesive that meets the requirements is acceptable. For example, the fixing adhesive may be at least one of UV-curable adhesion agent (such as UV adhesive, i.e., shadowless adhesive, which requires curing under ultraviolet light irradiation), UV and moisture-curable adhesion agent, or low-temperature (e.g., low temperature refers to below 100° C.) curable adhesion agent. Thus, in some embodiments of the present disclosure, the fingerprint module 100 may be mounted between the screen 220 (foldable screen) by dispensing adhesive once (i.e., the aforementioned fixing adhesive (i.e., the fourth fixing structure 244)), thereby meeting both the light-shielding and module-fixing requirements. Alternatively, as shown in FIG. 9, FIG. 11, FIG. 13 and FIG. 15, after the first electrical connection region 1016 and the second electrical connection region 1021 are electrically connected via the conductive adhesive layer 103 (e.g., ACF), the protective adhesive 105 may be added to an outer side of the conductive adhesive layer 103 to protect the conductive adhesive layer 103.

It should be noted that depending on the needs of implementation, the various components/steps described in the embodiments of the present disclosure may be divided into more components/steps, or two or more components/steps, or parts of the components/steps, may be combined into new components/steps to achieve the objectives of the embodiments of the present disclosure.

Those skilled in the art may recognize that the units and method steps described in the examples disclosed herein in the embodiments can be implemented using electronic hardware, or a combination of computer software and electronic hardware. Whether these functions are executed in hardware or software depends on the specific application and design constraints of the technical solution. Those skilled in the art may use different methods to implement the described functions for each specific application, but such implementation should not be considered to fall outside the scope of the embodiments of the present disclosure.

The above embodiments are provided for illustrative purposes only and are not intended to limit the scope of the present disclosure. Those skilled in the art may make various changes and modifications without departing from the spirit and scope of the embodiments of the present disclosure. Therefore, all equivalent technical solutions also fall within the scope of the embodiments of the present disclosure, and the scope of patent protection of the embodiments of the present disclosure should be defined by the claims.

1. A fingerprint module, comprising: an ultrasonic sensor and a circuit board;
the ultrasonic sensor comprising a substrate, an acoustic layer, a first electrode layer, and a protective layer, the substrate being provided with a second electrode layer, one side of the acoustic layer being electrically connected to the second electrode layer, the other side of the acoustic layer being electrically connected to one side of the first electrode layer, and the protective layer being covered on the other side of the first electrode layer, wherein a sum of thicknesses of the acoustic layer, the first electrode layer, and the protective layer ranges from 44 μm to 50 μm, and a thickness of the substrate ranges from 85 μm to 115 μm;
the substrate being provided with a first electrical connection region, the first electrode layer and the second electrode layer being electrically connected to the first electrical connection region, respectively, the circuit board being provided with a second electrical connection region, and the first electrical connection region and the second electrical connection region being electrically connected via a conductive adhesive layer; and
the circuit board being electrically connected to a processing unit external to the fingerprint module, the acoustic layer being configured to emit an ultrasonic signal and receive an ultrasonic signal reflected by an external structure, the ultrasonic sensor being configured to convert the ultrasonic signal received by the acoustic layer into an electrical signal and send the electrical signal to the processing unit via the circuit board to enable the processing unit to perform fingerprint recognition based on the electrical signal, wherein a frequency of the ultrasonic signal emitted by the acoustic layer ranges from 9 MHz to 11 MHz.

2. The fingerprint module according to claim 1, wherein,
the sum of the thicknesses of the acoustic layer, the first electrode layer, and the protective layer is 47 μm, the thickness of the substrate is 90 μm, and the frequency of the ultrasonic signal emitted by the acoustic layer is 10 MHz.

3. The fingerprint module according to claim 1, wherein,
the second electrode layer comprises a plurality of complementary metal oxide semiconductors formed on the substrate, and at least some of the plurality of complementary metal oxide semiconductors are electrically connected to the one side of the acoustic layer; and
the first electrode layer and the second electrode layer are configured to provide the acoustic layer with voltages required for emitting and receiving ultrasonic signals.

4. The fingerprint module according to claim 1, wherein, the first electrical connection region and the second electrode layer are located on a same side of the substrate.

5. The fingerprint module according to claim 1, wherein, the first electrical connection region comprises a plurality of pins arranged side by side, each of the plurality of pins has a width of 0.09 mm, a length of each of the plurality of pins ranges from 0.3 mm to 0.385 mm, and a distance between two adjacent pins is 0.07 mm; and
at least some of the plurality of pins are electrically connected to the second electrical connection region.

6. The fingerprint module according to claim 5, wherein,
each of the plurality of pins is provided with a conductive plating layer, wherein, the conductive plating layer is provided on a connection side of each of the plurality of pins with the conductive adhesive layer.

7. The fingerprint module according to claim 1, wherein, the fingerprint module further comprises: an adhesive layer;
the adhesive layer comprises a first double-sided adhesive, a first copper foil layer and a second double-sided adhesive, one side of the first copper foil layer is adhered to one side of the first double-sided adhesive, the other side of the first copper foil layer is adhered to one side of the second double-sided adhesive, the other side of the second double-sided adhesive is adhesively bonded to the substrate, and the second double-sided adhesive and the acoustic layer are located on two sides of the substrate, respectively; and
the other side of the first double-sided adhesive is adhesively bonded to an electronic device external to the fingerprint module.

8. The fingerprint module according to claim 7, wherein,
the first double-sided adhesive has a thickness of 6 μm, the first copper foil layer has a thickness of 6 μm, and the second double-sided adhesive has a thickness of 3 μm; or
the first double-sided adhesive has a thickness of 6 μm, the first copper foil layer has a thickness of 35 μm, and the second double-sided adhesive has a thickness of 6 μm; or
the first double-sided adhesive has a thickness of 6 μm, the first copper foil layer has a thickness of 16 μm, and the second double-sided adhesive has a thickness of 6 μm.

9. The fingerprint module according to claim 1, wherein, the conductive adhesive layer comprises an anisotropic conductive adhesive, and the anisotropic conductive adhesive has a thickness of 3 μm.

10. The fingerprint module according to claim 1, wherein, a protective adhesive is covered on a side of the conductive adhesive layer that extends beyond the substrate, and the protective adhesive is in contact with at least the substrate, the conductive adhesive layer and the circuit board.

11. The fingerprint module according to claim 1, wherein, the circuit board comprises a flexible circuit board, and the flexible circuit board comprises a first cover film, a first electroless copper layer, a second copper foil layer, a substrate layer, a third copper foil layer, a second electroless copper layer, and a second cover film;
one side of the first cover film is attached to one side of the first electroless copper layer, the other side of the first electroless copper layer is attached to one side of the second copper foil layer, the other side of the second copper foil layer is attached to one side of the substrate layer, the other side of the substrate layer is attached to one side of the third copper foil layer, the other side of the third copper foil layer is attached to one side of the second electroless copper layer, and the other side of the second electroless copper layer is attached to one side of the second cover film; and
at one end of the flexible circuit board, the first cover film, the first electroless copper layer, and the second copper foil layer are indented by a first distance relative to the substrate layer, the third copper foil layer and the second electroless copper layer are indented by a second distance relative to the substrate layer, the second cover film is indented by a third distance relative to the substrate layer, the first distance is greater than the second distance, and the third distance is greater than the second distance, wherein, the second cover film is indented relative to the third copper foil layer and the second electroless copper layer to form the second electrical connection region.

12. An electronic device, comprising: a processing unit, a screen, and a fingerprint module; wherein, the fingerprint module comprises an ultrasonic sensor and a circuit board;
the ultrasonic sensor comprises a substrate, an acoustic layer, a first electrode layer, and a protective layer, the substrate being provided with a second electrode layer, one side of the acoustic layer being electrically connected to the second electrode layer, the other side of the acoustic layer being electrically connected to one side of the first electrode layer, and the protective layer being covered on the other side of the first electrode layer, wherein a sum of thicknesses of the acoustic layer, the first electrode layer, and the protective layer ranges from 44 μm to 50 μm, and a thickness of the substrate ranges from 85 μm to 115 μm;
the substrate being provided with a first electrical connection region, the first electrode layer and the second electrode layer being electrically connected to the first electrical connection region, respectively, the circuit board being provided with a second electrical connection region, and the first electrical connection region and the second electrical connection region being electrically connected via a conductive adhesive layer; and
the circuit board being electrically connected to a processing unit external to the fingerprint module, the acoustic layer being configured to emit an ultrasonic signal and receive an ultrasonic signal reflected by an external structure, the ultrasonic sensor being configured to convert the ultrasonic signal received by the acoustic layer into an electrical signal and send the electrical signal to the processing unit via the circuit board to enable the processing unit to perform fingerprint recognition based on the electrical signal, wherein a frequency of the ultrasonic signal emitted by the acoustic layer ranges from 9 MHz to 11 MHz,
wherein, the fingerprint module is provided at a back side of the screen, and the processing unit is electrically connected to a circuit board in the fingerprint module.

13. The electronic device according to claim 12, wherein, the screen is a non-foldable screen, the screen comprises a screen substrate and a buffer layer attached together, and the buffer layer is configured to buffer the screen; and
the buffer layer is provided with a first through-hole, the fingerprint module comprises an ultrasonic sensor, the ultrasonic sensor passes through the first through-hole and is adhesively bonded to the screen substrate via an adhesive layer.

14. The electronic device according to claim 13, wherein, the buffer layer has a same color as a first double-sided adhesive comprised in the adhesive layer.

15. The electronic device according to claim 13, wherein, the electronic device further comprises a first light-shielding structure and a first fixing structure, wherein the first light-shielding structure is configured to cover a gap formed between an edge of the adhesive layer and an edge of the first through-hole, and the first fixing structure is configured to fix an edge of the ultrasonic sensor onto the adhesive layer.

16. The electronic device according to claim 15, wherein, the first light-shielding structure comprises a light-shielding adhesive, and a curing shrinkage rate of the light-shielding adhesive is less than 3%.

17. The electronic device according to claim 15, wherein, the first fixing structure comprises a fixing adhesive, and a curing shrinkage rate of the fixing adhesive is less than 3%.

18. The electronic device according to claim 15, wherein, the electronic device further comprises a second fixing structure, and the second fixing structure is configured to fix an edge of the ultrasonic sensor onto the screen substrate.

19. The electronic device according to claim 12, wherein,
the screen is a foldable screen, the screen comprises a support sheet, and the support sheet is configured to support the screen; and
the fingerprint module comprises an ultrasonic sensor, and the ultrasonic sensor is adhesively bonded to the support sheet via an adhesive layer.

20. The electronic device according to claim 19, wherein, the electronic device further comprises a third fixing structure, and the third fixing structure is configured to fix an edge of the ultrasonic sensor onto the adhesive layer.
